(19) United States
(12) Patent Application Publication
(10) Pub. No.: US 2002/0070491 A1
(43) Pub. Date: Jun. 13, 2002

(54) Method for securing workpieces

(75) Inventors: Kurt Schmalz, Dornstetten (DE); Ralf Stockburger, Glatten (DE); Jochen Burkhardt, Lossburg-Witendorf (DE)

Correspondence Address: Dreiss, Fuhlendorf, Steimle & Becker, Patentanwalte, Postfach 10 37 62, D-70032 Stuttgart, DE

(73) Assignee: J. Schmalz GmbH, Glatten (DE)

(21) Appl. No.: 09/985,978

(22) Filed: Nov. 7, 2001

(30) Foreign Application Priority Data
Nov. 8, 2000 (DE) 100 55 379.6

(51) Int. Cl. B25B 11/00

(52) U.S. Cl. 269/21

(57) ABSTRACT

The invention concerns a device for securing workpieces with at least one clamping bar and a block suction apparatus disposed on the clamping bar. The block suction apparatus is secured to a slide which can be transported in the longitudinal direction of the clamping bar. The block suction apparatus can be lifted from the surface of the clamping bar.

This application claims Paris Convention priority of DE 100 55 379.6 filed Nov. 8, 2000 the complete disclosure of which is hereby incorporated by reference.

### BACKGROUND OF THE INVENTION

The invention concerns a device for securing workpieces, in particular, plate-shaped workpieces, with at least one clamping bar and at least one slide which can be transported on the clamping bar, to transport at least one block suction apparatus in the longitudinal direction of the clamping bar, and a driving device for the at least one slide.

EP 0 687 521 A1 discloses a device for fixing workpieces, wherein the workpiece is disposed on a plurality of block suction devices and is retained thereby. These block suction devices are disposed on slides which can be transported in a first direction. The block suction devices themselves can also be transported on the slides and have a drive therefor. The device is disadvantageous in that a plurality of drives is required for transporting the block suction devices.

It is the object of the invention to provide a device of the above-mentioned type with a reduced number of drives.

### SUMMARY OF THE INVENTION

This object is achieved in accordance with the invention with a device of the above-mentioned type in that the slide comprises a coupling by means of which the slide can be coupled to the drive device and be decoupled from same at the desired position.

In the inventive device, the slide is connected to the drive device by means of a coupling such that the slide is transported by the drive device in the longitudinal direction of the clamping bar only if it is coupled thereto. When the coupling is released, the drive device does not change the position of the slide. The drive device can be used for other purposes, e.g. for transporting other slides whose coupling is coupled to the drive device. In accordance with the invention, the drive device is used not only for transporting one single slide but for transporting several slides.

In a further development, the coupling is formed as a clamping device. This clamping device permits coupling of the slide to or decoupling from the drive device in a reliable and straightforward fashion. This can be effected pneumatically, hydraulically or electromagnetically. A coupling which is pneumatically actuated by underpressure is thereby preferred since the clamping bar is usually provided with pneumatic lines. Tapping of the underpressure is therefore straightforward.

In a preferred embodiment, the drive device comprises a drive motor and a circulating drive belt. This drive belt, which can be driven by the drive motor in both directions of circulation, serves for transporting the slide on the clamping bar. Towards this end, the drive belt is guided through or past the slide such that it can be connected to the slide by means of the coupling. Either of the two sides of the drive belt can be coupled to the slide to permit transport of the slide in both directions. For several slides, it is possible to transport one slide in one direction while simultaneously transporting the other slide in the other direction without having to change the direction of rotation of the drive motor.

In a preferred embodiment, the slide is provided with a sprocket via which the drive belt, formed as a toothed belt, is guided. The sprocket has the substantial advantage that it can be connected to the toothed belt without slippage. The sprocket itself is secured on the slide in a rotatable but otherwise stationary fashion.

The clamping device preferably comprises a clamping block which can be pressed against the sprocket or onto the toothed belt. This clamping block prevents idle running of the sprocket independent of the position of the toothed belt or sprocket, thereby connecting the slide to the toothed belt.

A further feature of the invention provides that the at least one block suction apparatus can be lifted from the clamping bar by means of the coupling. This has the advantage that the block suction apparatus seal no longer contacts the clamping bar to prevent damage to the seal during the transport process. Processing remnants lying on the surface of the clamping bar can no longer damage the seal during transport of the block suction apparatus.

Further advantages, features and details of the invention can be extracted from the dependent claims and the following description which describes in detail a particularly preferred embodiment with reference to the drawing. The features shown in the drawing and recited in the claims and in the description can be essential to the invention either individually or collectively in any arbitrary combination.

### BRIEF DESCRIPTION OF THE DRAWING

FIG. 1 shows a perspective view of a clamping bar with indicated slide; and

FIG. 2 shows an enlarged perspective representation of the slide.

### DESCRIPTION OF THE PREFERRED EMBODIMENT

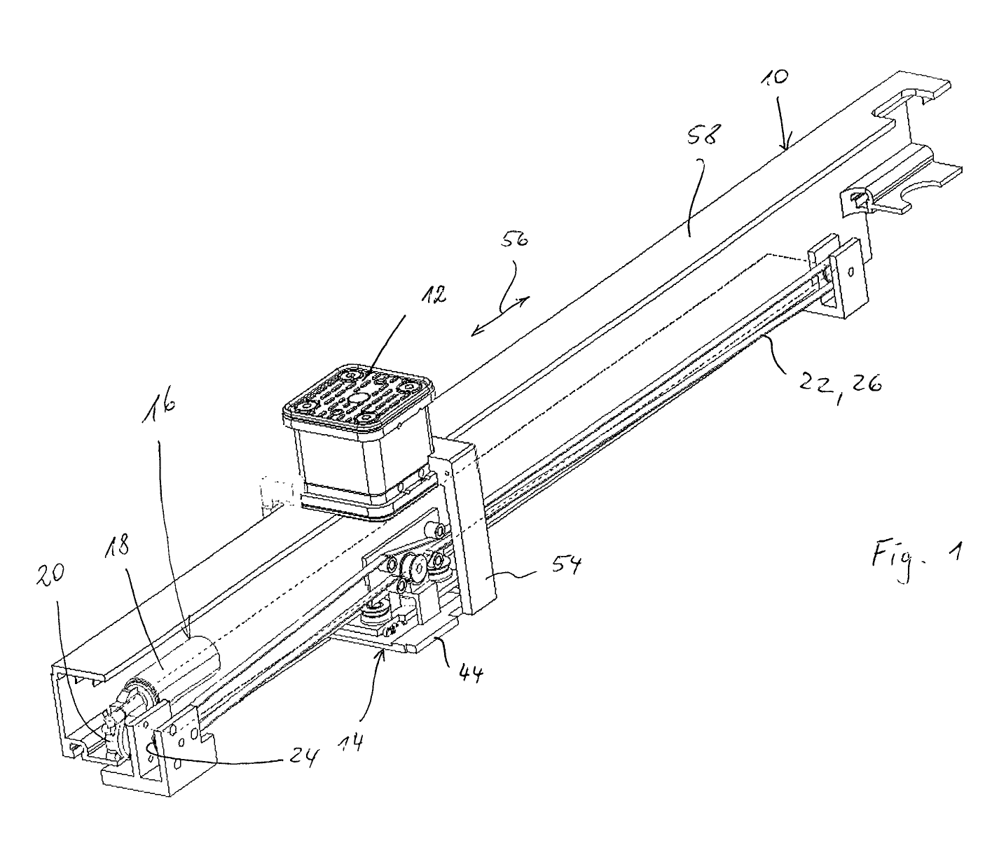

FIG. 1 shows a perspective representation of a clamping bar, designated in its totality with 10, on which one or more block suction apparatus 12 can be transported. The clamping bar comprises one slide 14 for each block suction apparatus, wherein FIG. 1 shows only one of these slides 14. FIG. 1 also shows a drive device, referred to in its totality with 16, which is formed by a drive motor 18, an angular gear 20 with a transmission gearing and a drive belt 22. This drive belt 22 embraces a drive wheel 24 having an outer toothing and driven by the angular gear 20. The drive belt 22 is designed as toothed belt 26.

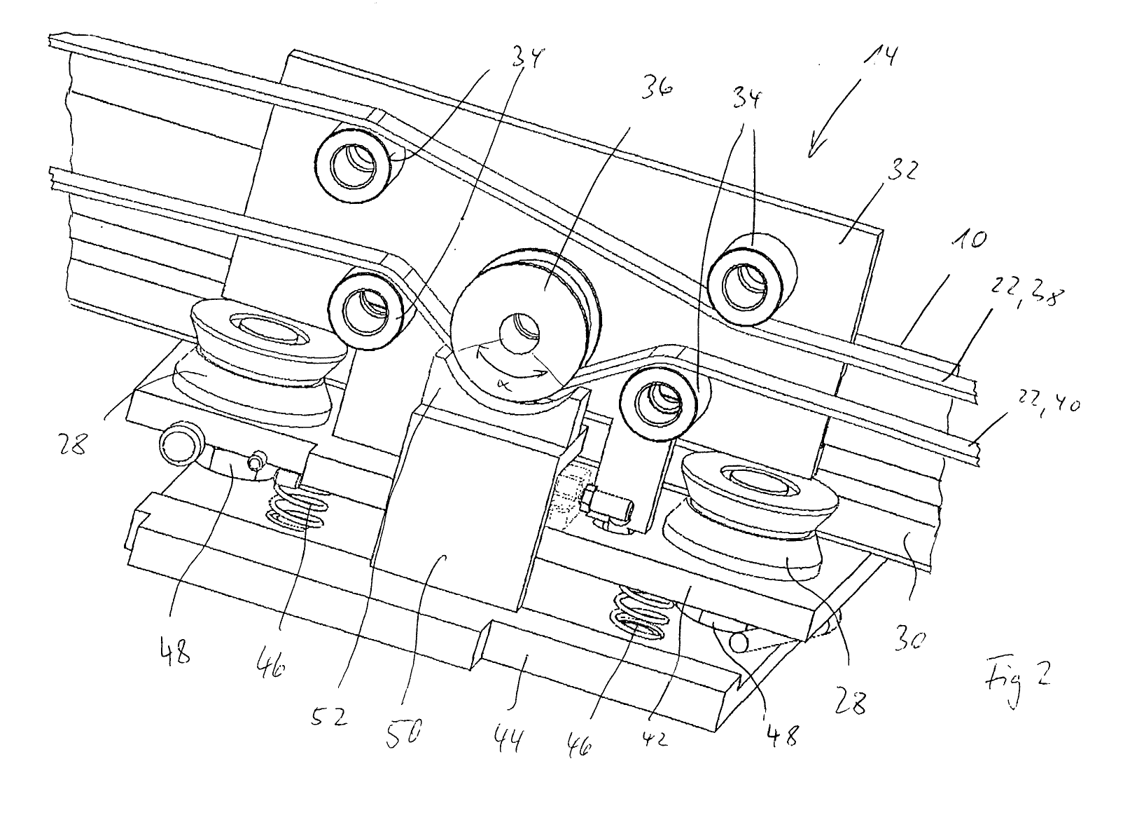

This slide 14, shown in an enlarged representation in FIG. 2, is guided on corresponding guide rails 30 on the clamping bar 10 via pulleys 28. The slide 14 is furthermore provided with a vertical plate 32 on which guiding rollers 34 and a sprocket 36 are rotatably disposed. The toothed belt 26 comprises an upper side 38 and a lower side 40. The upper side 38 is guided by the two upper guiding rollers 34 whereas the lower side 40 is guided about the sprocket 36 through an angle a. The teeth of the sprocket 36 thereby engage in the teeth (not shown) of the toothed belt 26. The sprocket 36 is disposed on the plate 32 in a freely rotatable fashion such that it is driven via the toothed belt 26 without slippage.

The plate 32 is connected to a base plate 42 on which the two pulleys 28 are rotatably disposed. A lifting plate 44 is located below the base plate 42 and is held at a separation from the base plate 42 by means of springs 46. Underpressure drives 48 for the lifting plate 44 are located between the base plate 42 and the lifting plate 44. These underpressure drives 48 can move the lifting plate 44 against the force of the spring 46 in the direction of the base plate 42 to thereby displace a braking arm 50, provided on the lifting plate 44, such that a clamping block 52 presses the lower side 40 of the drive belt 22 against the sprocket 36 thereby blocking the rotation of the sprocket 36. The slide 14 is then coupled to the lower side 40 of the drive belt 22. As the drive belt 22 is driven by the drive motor 18, the slide 14 is carried along in the running direction of the lower side 40. When the slide 14 has assumed the desired position on the clamping bar 10, the clamping is released by displacement of the lifting plate 44 towards the bottom i.e. away from the base plate 42. The clamping block 52 is thereby removed from the drive belt 22 and the sprocket 36 can be rotated without hindrance. The slide 14 remains in this position.

FIG. 1 also shows that the lifting plate 44 is connected to the block suction apparatus 12 via a connecting leg 54. This connecting leg 54 serves for carrying along the block suction apparatus 12 in the transport direction (double arrow 56) and for lifting the block suction apparatus 12 from the upper side 58 of the clamping bar 10 during transport. The block suction apparatus 12 is lifted when the lifting plate 44 is lifted and the drive belt 22 is clamped to the sprocket 36.

In accordance with the invention, several slides 14 can be connected to the drive belt 22 independent of one another. Several slides 14 and therefore several block suction apparatus 12 can then be transported on the clamping bar 10 independently of one another using one single drive device 16.

If the upper side 38 of the drive belt 22 is coupled to a given slide 14, that slide 14 and therefore also the associated block suction apparatus 12 are transported in the opposite direction for a same rotational direction of the drive motor 18.

We claim:

1. A device for securing workpieces and plate-shaped workpieces, the device comprising:
at least one clamping bar;
at least one slide transported on said clamping bar;
at least one block suction device mounted to said slide for transport in a longitudinal direction of said clamping bar;
driving means communicating with said slide to transport said slide along said clamping bar; and
means for coupling and decoupling said slide to said driving means at desired locations of said slide along said clamping bar.

2. The device of claim 1, wherein said coupling means comprises a clamping device.

3. The device of claim 1, wherein said driving means comprises a drive motor and a circulating drive belt, said drive belt having a first belt run travelling in a first direction and a second belt run travelling in a second direction opposite to said first direction.

4. The device of claim 3, wherein at least one of said first belt run and said second belt run is guided through said coupling means.

5. The device of claim 4, wherein said coupling means couples at least one of said first and said second belt run to said slide.

6. The device of claim 3, wherein said slide has a sprocket communicating with said drive belt, said drive belt having teeth engaging in said sprocket.

7. The device of claim 6, wherein said coupling means comprises a clamping device, said clamping device having a clamping block which can be pressed onto at least one of said sprocket and said toothed belt.

8. The device of claim 1, wherein said coupling means comprises at least one of pneumatic, hydraulic and electromagnetic activation means.

9. The device of claim 1, wherein said at least one block suction apparatus can be lifted from said clamping bar by said coupling means.
